(19) United States
(12) Patent Application Publication
(10) Pub. No.: US 2007/0260373 A1
(43) Pub. Date: Nov. 8, 2007

(54) Dynamic vehicle durability testing and simulation

(76) Inventors: William J. Langer, Minnetrista, MN (US); Daniel Barsness, Victoria, MN (US)

Correspondence Address: MCDERMOTT, WILL & EMERY, 4370 LA JOLLA VILLAGE DRIVE, SUITE 700, SAN DIEGO, CA, 92122, US

(21) Appl. No.: 11/430,810

(22) Filed: May 8, 2006

(51) Int. Cl. G06F 19/00

(52) U.S. Cl. 701/29; 703/8

(57) ABSTRACT

A dynamic vehicle tester providing integrated testing and simulation for determining characteristics of a unit under test. Changes occurred on the unit under test are dynamically obtained, considered and incorporated in generating test conditions to be applied to the unit under test. Additionally, durability testing is conducted using such techniques that compares a physical specimen under test to a real-time model of that specimen.

### FIELDS OF DISCLOSURE

This application generally relates to vehicle durability testing and evaluations, and more specifically, to an integrated and dynamic testing approach that considers changes of a vehicle part under test over time, in applying test conditions and determining durability characteristics of the vehicle part.

### BACKGROUND

Laboratory simulations and track tests are widely used in the automotive industry to evaluate and verify characteristics, designs and durability of a vehicle and/or a component or subsystem thereof. However, either track tests or conventional simulations have drawbacks. Track tests usually are time consuming and expensive. In some cases, track tests are impractical or even impossible because a finalized design of a new vehicle may be unavailable to determine the interactions between one or more subsystems of the vehicle and the vehicle itself.

One type of simulation called hardware-in-the-loop (HIL) uses software algorithms and mathematical vehicle models to simulate the interactions between the vehicle and a circuit prototype to evaluate the design of the circuit. Conventional HIL simulations, though less expensive than track tests, only evaluate electronic signals between the circuit under test and the vehicle model, but do not test the combination of electronic, software and mechanical components collectively in the presence of real forces and motion.

One shortcoming of these conventional techniques is that the actual loads and displacements applied to a subsystem are vehicle dependent. Thus, a relatively whole vehicle (or similar vehicle) is required to gather load time histories (i.e., the test conditions) that are used for durability testing. Such vehicles are often not available, especially early in the design process. Furthermore, in durability tests, test conditions are applied to a component or subsystem for a specified number of repetitions or until component or subsystem failure. The durability tests assume that characteristics of the component or subsystem under test remain unchanged during the test process, and hence the testing conditions and vehicle models do not change. However, in reality, characteristics of the component under durability tests change over time, and in turn affect the vehicle model and test parameters or test conditions. For instance, a vehicle suspension under test may change as a load history is applied repeatedly. On the road, this would mean that the actual loads applied to the suspension also change because of its changing interaction with the vehicle and the road. If the simulation does not consider the changes in the test parameters or conditions, the test result would be unreliable.

The proliferation of electro-mechanical systems, also known as mechatronics, in a variety of different vehicles has recently increased as well. No longer reserved for engines and transmissions alone, mechatronic systems are now available for dampers, steering systems, sway-bars, as well as other vehicle systems. As the breadth and technical capability of mechatronics applications increase, so do the design, calibration, and troubleshooting challenges.

Therefore, there is a need to provide an integrated vehicle simulation and testing for evaluating the combination of electronic, software and mechanical components collectively. Moreover, there is a need to provide a vehicle model that dynamically addresses the changes in the characteristics of the component under test.

### SUMMARY

This disclosure describes embodiments of vehicle simulations that address some or all of the above-described needs. Accordingly, one aspect of the present invention relates to a method of testing durability characteristics of a subsystem of a vehicle. In accordance with this method, a first model is executed that excludes a component of the subsystem and a second model is executed that includes the component of the subsystem. The output of the first model related to the component is provided as first input to a test rig and as second input to the second model. Next, the test rig including a physical specimen of the component is operated so as to apply the first input to the physical specimen. A first response of the physical specimen resulting from application of the first input is detected and a second response of the second model resulting from application of the second input is detected.

Another aspect of the present invention relates to a tester for testing durability of a subsystem of a vehicle. This tester includes at least one test rig actuator configured to apply a test condition to at least a portion of the subsystem, at least one sensor configured to collect signals related to the portion subsystem, and a data processing system. The system is configured to store machine-executable instructions and data related to a simulation model representing the vehicle not including the portion of the subsystem. Upon execution by a data processor, these instructions control the system to perform the steps of: a) generating test signals using the simulation model; b) controlling the at least one test rig actuator to apply a test condition to the portion of the subsystem based on the test signals; c) receiving response signals of the portion of the subsystem to the test condition based on the test signals; and d) generating a durability test result based on the received response signals.

Yet another aspect of the present invention relates to a method of testing durability characteristics of a subsystem of a vehicle. In accordance with this method, an model is executed wherein the model excludes at least a component of the subsystem; as a result output of the model related to the component is provided as first input to a test rig. The test rig, including a physical specimen of the component, is operated so as to apply the first input to the physical specimen. Then, a response of the physical specimen resulting from application of the first input is detected so that signals representing the response can be provided as second input to the model, wherein the model uses the second input when executing.

The foregoing and other features, aspects and advantages of the disclosed embodiments will become more apparent from the following detailed description and accompanying drawings.

### BRIEF DESCRIPTION OF THE DRAWINGS

The present disclosure is illustrated by way of example and not by way of limitation, in the figures of the accompanying drawings and in which like reference numerals refer to similar elements.

FIGS. 1a and 1b show an active roll control system.

FIGS. 2a and 2b illustrate the effects of an active roll control system to a vehicle.

FIG. 3 depicts a block diagram of an exemplary integrated tester for evaluating the combination of electronic, software and mechanical components collectively.

FIG. 4 shows an exemplary construction of a tester according to this disclosure.

FIG. 5 shows another exemplary construction of a tester according to this disclosure.

FIG. 6a illustrates subsystems of a vehicle.

FIG. 6b depicts a block diagram of an exemplary dynamic tester that incorporates changes in a subsystem in applying test conditions.

FIG. 7a depicts a block diagram of another exemplary dynamic tester that is usable for performing a durability test.

FIG. 7b depicts a flowchart of an exemplary method for conducting durability testing of a vehicle subsystem.

FIG. 8 is an exemplary data processing system upon which an embodiment of this disclosure may be implemented.

### DETAILED DESCRIPTION

For illustration purposes, the following descriptions describe various illustrative embodiments of testers for testing a vehicle, such as an automobile, airplane, etc.; and/or one or more subsystems thereof, such as an actively controlled suspension system, active rolling control system, etc. It will be apparent, however, to one skilled in the art that concepts of the disclosure may be practiced or implemented without these specific details. In other instances, well-known structures and devices are shown in block diagram form in order to avoid unnecessarily obscuring the present disclosure.

An automobile includes various subsystems for performing different functions such as power train, driver interface, climate and entertainment, network and interface, lighting, safety, engine, braking, steering, chassis, etc. Each subsystem further includes components, parts and other subsystems. For instance, a power train subsystem includes a transmission controller, a continuously variable transmission (CVT) control, an automated manual transmission system, a transfer case, an all wheel drive (AWD) system, an electronic stability control system (ESC), a traction control system (TCS), etc. A chassis subsystem may include active dampers, magnetic active dampers, body control actuators, load leveling, anti-roll bars, etc. Designs and durability of these subsystems need to be tested and verified during the design and manufacturing process. Accordingly, embodiments of the present invention relate to durability testing of active or passive subsystems, portions of such subsystems, or one or more active or passive components of such subsystems.

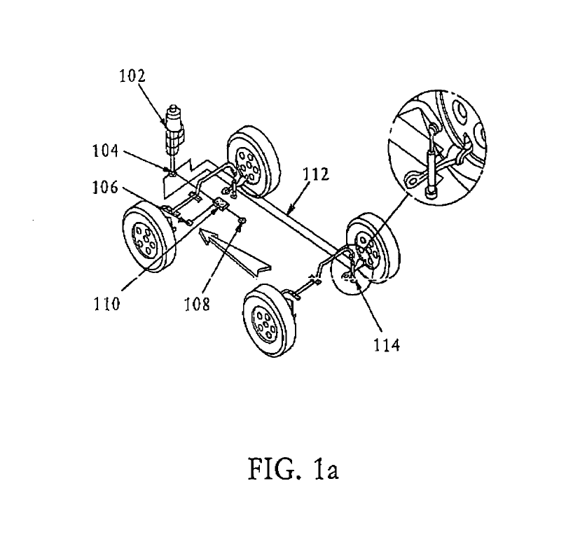

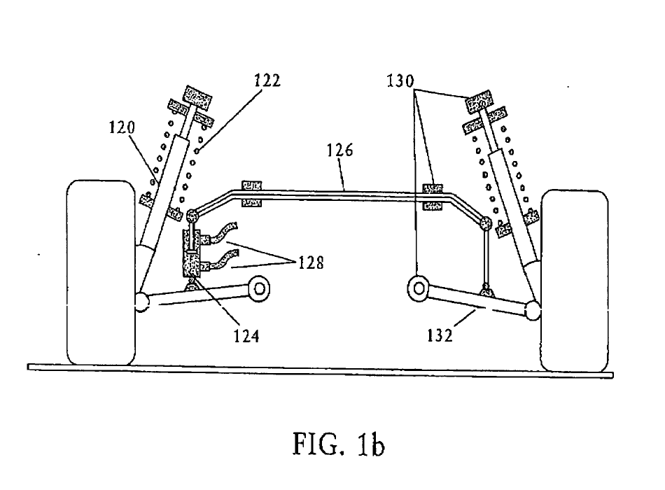

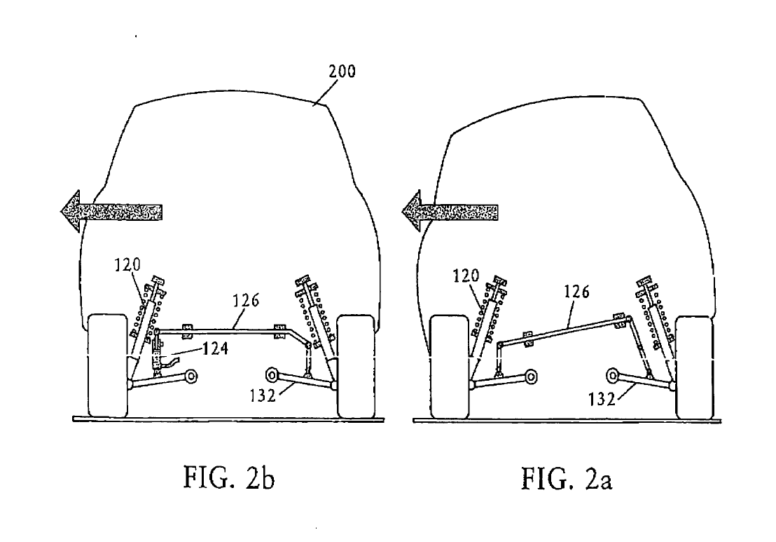

Some of the subsystems use electronic control units (ECU) that actively monitor the driving condition of a vehicle and dynamically adjust the operations and/or characters of the subsystems, to provide better control or comfort. FIGS. 1a and 1b show an exemplary active roll control system of an automobile. The active roll control system of the example includes a motor pump assembly 102, a valve block 104, a steering angle sensor 106, a lateral accelerometer 108, an electronic control unit (ECU) 110, hydraulic lines 112 and linear actuators 114. FIG. 1b depicts such an active system along with other components of a vehicle's suspension. Thus, a McPherson strut, a spring 122, an actuator 124, a stabilizer bar 126, a cross-over valve connector 128, bushings 130, and a control arm 132 are depicted as components of an exemplary suspension system. As illustrated in FIG. 2a, if an automobile does not have an active roll control system, the cornering force can cause a significant body lean of the automobile when making turns. On the other hand, as shown in FIG. 2b, if an automobile is equipped with an active roll control system, once the ECU 110 determines that the automobile is making a turn, it controls the actuator 124 to deflect the stabilizer bar 126, which minimizes the body lean of the automobile 200 when making a turn.

Another example of active subsystems is an actively controlled suspension system. An actively controlled suspension system may include such components, for example, as an ECU, adjustable shocks and springs, a series of sensors at each wheel and throughout the car, and an actuator or servo atop each shock and spring. When the automobile drives over a pothole, the sensors pick up yaw and transverse body motion, and sense excessive vertical travel due to the pothole. The ECU collects, analyzes and interprets the sensed data, and controls the actuator atop the shock and spring to “stiffen up.” To accomplish this, an engine-driven oil pump sends additional fluid to the actuator, which increases spring tension, thereby reducing body roll, yaw, and spring oscillation.

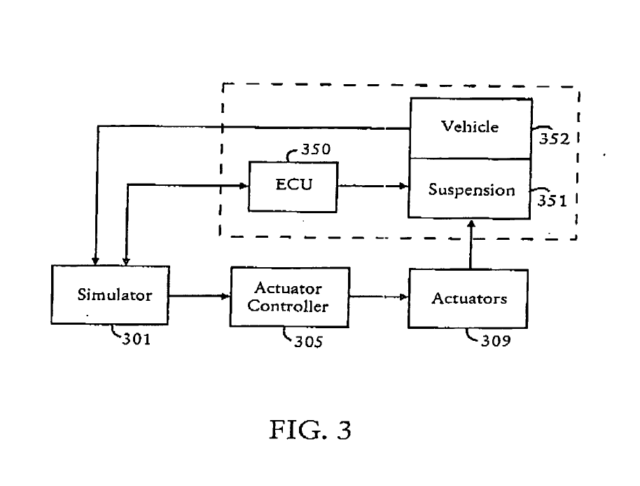

FIG. 3 depicts a block diagram of an exemplary integrated dynamic tester that tests the combination of electronic, software and mechanical components of an actively controlled suspension system. The exemplary tester exposes at least one axle of a vehicle under test to realistic loads based on simulated road and vehicle dynamic inputs.

The exemplary tester includes an real-time vehicle simulation model 301, an actuator controller 305 and actuators 309. An actively controlled suspension system includes ECU 350 and a vehicle suspension 351. A test may be performed with a complete or incomplete vehicle 352, or even without a vehicle at all. The simulation 301 may, as depicted, communicate with an ECU 350 that is part of the component under test. In other instances the component being tested may not include an ECU, or the simulation 301 may not communicate with the ECU 350. Accordingly, the use of the phrase “real-time vehicle simulation model” below is used by way of example to refer to the arrangement of FIG. 3 in which the simulation interacts with the ECU 350. However, embodiments of the present invention also contemplate that the simulation 301 may be a more traditional computer-based simulation that does not necessarily interact with an ECU.

Real-time vehicle simulation model 301 performs real-time simulations of the operation of a vehicle under selected test conditions based on a simulation model related to the vehicle. The construction and use of the simulation model depends on whether suspension 351 is tested with a complete or incomplete vehicle, or without a vehicle at all. Other information included in the simulation model includes information related to an engine model, drive train model, tire model, or any other components relevant to the suspension. Physical parts of the vehicle or suspension that do not exist are modeled and incorporated in real-time vehicle simulation model 301. The simulation model uses parameters or other data to configure the desired properties of the real vehicle or suspension. Modeling techniques are widely used and known to people skilled in the art. Companies supplying tools for building simulation models include Tesis, dSPACE, AMESim, Simulink. Companies that provide HIL include dSPACE, ETAS, Opal RT, A&D, etc. An exemplary vehicle model includes at least one of engine, power train, suspension, wheel and tires, vehicle dynamics, aerodynamics, driver behavior patterns, road conditions, brakes, body mass, center of gravity, passenger load, cargo load, body dimensions, thermal dynamic effects, clutch/torque converter, etc.

Real-time vehicle simulation model 301 has access to a test condition database which includes data related to a road profile, driving course, a driver's inputs, a surface definition, a driver model, test scenario, speed, direction, driving maneuvers, braking, etc. In one embodiment, a road profile includes a map of the road surface elevation versus distance traveled, vehicle turns, etc. Additionally, the available information may include complete environmental information such as attributes of the road path and the road surface. Thus, not only x,y,z positional coordinates may be included but attributes such as, for example, friction (e.g., slippery road) and road surface type (e.g., gravel) may be included as well. The driver's inputs may be pre-stored or input by an operator of the tester. The operator may follow an arbitrary sequence (open loop driving), or the operator may adjust inputs in response to the current vehicle path as seen on a display of the tester (closed loop driving). The inputs will comprise of brake pressure, throttle position, and possibly steer wheel position. Suspension ECU 350 is provided to control vehicle suspension 351 based on input signals sent by real-time vehicle simulation model 301.

An exemplary real-time vehicle simulation model 301 is implemented using a data processing system, such as a computer, that includes one or more data processors for processing data, a data storage device configured to store instructions and data related to the simulation model, test condition database, etc. The instructions, when executed by the data processor, controls real-time vehicle simulation model 301 to perform functions specified by the instructions such as communicating with the ECU 350 and the actuator controller 305.

In operation, real-time vehicle simulation model 301 generates control signals to actuator controllers 305 based on the simulation model and data stored in the test condition database, to initiate applications of a test condition to suspension 351 and vehicle 352 by actuators 309. Exemplary test conditions applied by actuators 309 may include any of a variety of forces or moments. These forces and moments may be mutually orthogonal and be defined with respect to any of a number of different reference planes.

Furthermore, real-time vehicle simulation model 301 provides ECU 350 with information related to the operation of the vehicle under the specific test condition using the simulation model. For instance, the simulation model simulates the vehicle dynamics and driver's inputs from either a file or direct from an operator. Real-time vehicle simulation model 301 computes vehicle velocity and the loads the chassis would impose on the suspension from acceleration. The driver's inputs consist of throttle position, brake pressure and optionally steer wheel displacement.

In one embodiment, the simulation model includes a power train model assuming power proportional to throttle position. Interrupted power according to a shift schedule will result in a change in body force actuator command due to the acceleration transient, similar to the road. Driver's brake input will result in a braking force in the vehicle dynamics model resulting in a decrease in vehicle speed and change in body force due to deceleration. Acceleration will determine the inertial load transfer to the suspension. Road loads for grade, air resistance and rolling loss are combined with vehicle inertia and power train output to determine vehicle displacement, velocity and acceleration along the road path. Road vertical displacement will be applied as in a real road. Path acceleration will determine the inertial load transfer to the suspension. A steering input may also be considered. Steer input will result in lateral and yaw velocity changes for the simulated vehicle. A tire model can be used to produce the lateral forces as a function of slip angle and normal force. For simplicity, the road profile may be superimposed on the path that the vehicle takes to eliminate the necessity of an x-y description of the road plane. Steering inputs will result in a change in normal force to the suspension corner under test.

Based on the information provided by real-time vehicle simulation model 301, ECU 350 sends out commands to change characteristics of suspension 351, which in turn change the resulting body and suspension loads/position of vehicle 352. Sensors (not shown) are provided in appropriate portions of suspension 351 and vehicle 352 to obtain signals related to the responses to test conditions applied by actuators 309 and changes of physical characteristics initiated by ECU 350. Examples of the response signals include a deflection angle of the steering system, a camber angle, a vertical force and aligning torque, etc.

Furthermore, commands sent by ECU 350 are also made available to real-time vehicle simulation model 301. Based on the response signals of vehicle 352 and/or suspension 351, and commands sent by ECU 305, real-time vehicle simulation model 301 is able to perform collective evaluation of software, electronic and physical characteristics with actual or simulation loads. Data collected during the test is further used to performs evaluations of the actively controlled suspension system including suspension characterization and/or measurement based on the vehicle under test, designs of ECU 350, suspension 351 and/or vehicle 352, vehicle performance characterization and/or measurement based on the suspension under test, durability testing, model identification and verification, algorithm and control strategy development, algorithm validation, ECU calibration, regression testing, multiple system integration, etc. Within the umbrella of “durability testing”, such testing can serve a number of purposes such as component characterization, component validation, and component development. In one embodiment, a test report is generated including information listed above. The above-described steps are repeated during the test.

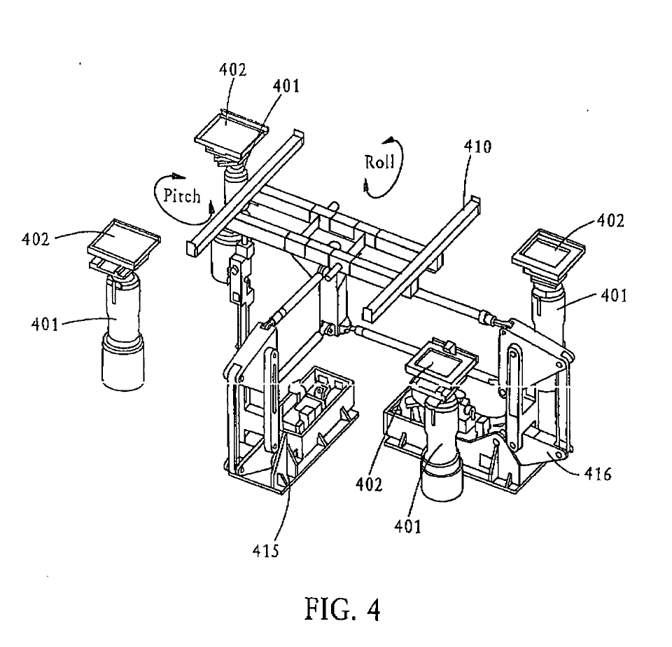

FIG. 4 shows an exemplary hardware construction of an integrated dynamic tester for testing characters of a suspension system. Posters 401 and supporting plates 402 are provided to support wheels or other subsystems of a vehicle. A supporting frame 410 provides support from underneath the body of a vehicle. Each poster 401 includes an actuator for applying a vertical force to the respective wheel of a vehicle and/or moving the respective supporting plate 402 in a vertical direction. Two additional actuators 415 and 416 are attached to supporting frame 410, to provide at least one of a lateral force, a longitudinal force, a roll or pitch motions or forces to a vehicle under test. Additional actuators may be provided to apply additional force or movements in additional dimensions. The actuators are controlled by simulation model 301 and actuator controller 305 to apply forces and/or movements to a suspension system and/or vehicle under test according to one or more test conditions specified by simulation model 301. It is understood that depending on design preference, different types or combinations of actuators can be provided to posters 401, supporting plates 402 and supporting frame 410, to move or apply forces to the subsystem and/or vehicle under test in different dimensions.

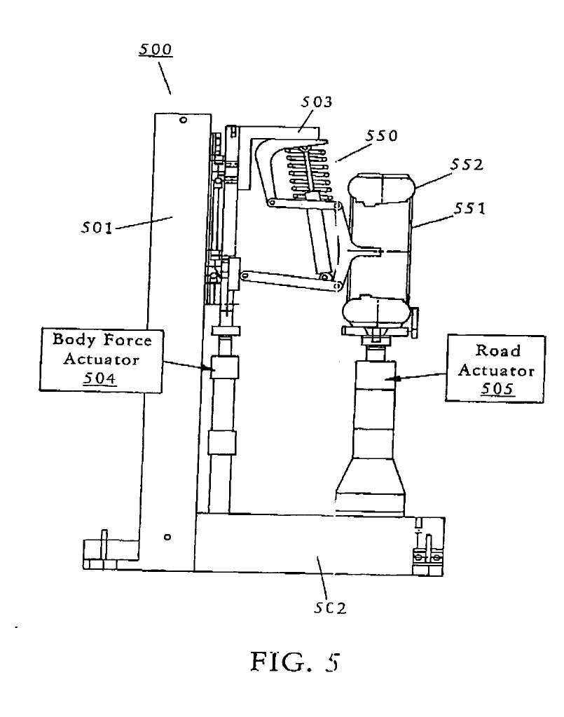

FIG. 5 shows another exemplary hardware construction of a dynamic tester 500 according to this disclosure. Integrated tester 500 includes a poster 501, a base 502 and a weighted control arm 503. Control arm 503 hinges on one end and has a suspension 550 mounted to the other end. Suspension 550 is guided by weighted control arm 503 in the vertical direction. A wheel module including wheel 551 and tire 552 is attached to suspension 550. A body force actuator 504 is provided to apply a force to the body side of suspension 550 corresponding to static weight on suspension 550, force transfer due to braking and/or acceleration, and force transfer due to cornering. In one embodiment, body force actuator 504 has swivels on both ends and is connected to weighted control arm 503. A road actuator 505 is located under tire 552 and supplies road displacement inputs or forces to suspension 550.

Similar to the embodiment shown in FIG. 4, road actuator 505 and body force actuator 504 are controlled by simulation model 301 and actuator controller 305 to apply forces and/or movements to a suspension system and/or vehicle under test according to one or more test conditions specified by simulation model 301. The responses of suspension 550 to the test conditions are collected by properly positioned sensors, and sent to real-time vehicle simulation model 301 for further processing.

Dynamic testers according to this disclosure are useful in performing durability tests on a subsystem of a vehicle, even when a prototype of the vehicle is not yet available, and incorporates dynamic modifications to reflect changes in the physical characteristics of the subsystem under test.

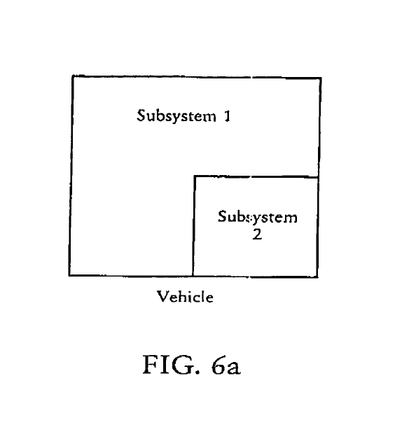

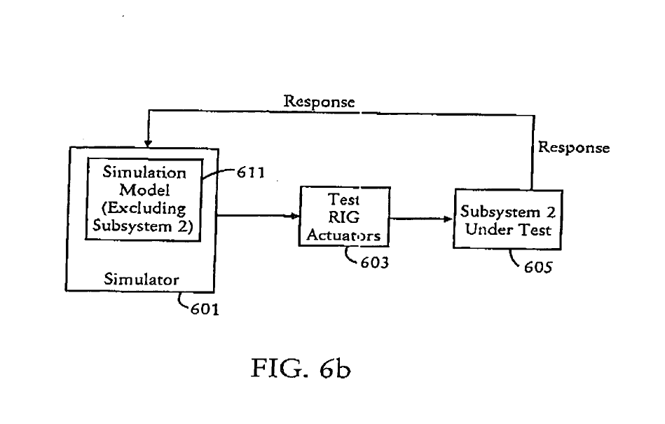

As shown in FIG. 6a, a vehicle incorporating a subsystem to be tested consists of subsystem 1 and subsystem 2. In one embodiment, subsystem 2 is the suspension undergoing a durability test, and subsystem 1 is everything on the vehicle other than subsystem 2. As shown in FIG. 6b, the exemplary dynamic tester performing the durability test includes real-time vehicle model simulator 601 and test rig actuators 603. Subsystem 2 is a physical part under test, such as a vehicle suspension. Simulator 601 includes a simulation model 611 representing characteristics of the vehicle excluding subsystem 2 under test. Characteristics of the suspension under test are removed from the model. The physical construction of the tester may be similar to those illustrated in FIG. 4 or 5, or any other constructions that are known to people skilled in the art to be suitable for performing tests.

In operation, simulator 601 generates a first set of test signals using simulation model 611 and data stored in a test condition database. The model 611 may, for example, be a tire-coupled model or a spindle-coupled model. The test condition database is similar to that described earlier. Based on the first set of test signals, test rig actuators 603 apply a test condition to subsystem 2. If subsystem 2 is a vehicle suspension, the applied test condition may be in the form of displacements or loads applied to the vehicle suspension, for example. In the instance in which subsystem 2 is an active system having an ECU (not shown), then a portion of the test signals or test condition may be provided to the ECU as well.

In general, the actuators 603 may be any type of machine capable of applying a load to subsystem 2. Accordingly, the applied load may be moments and forces but may also include thermal loads or other environmental variations (e.g., humidity).

Signals related to subsystem 2 and its responses to the applied test condition, such as complementary displacements or loads, are collected and sent to simulator 601. Based on the received response of subsystem 2, simulator 601 generates a new set of test signals by considering the effects and/or any changes of subsystem 2, so that any changes that may occur in the physical subsystem 2 under test are incorporated into the generation of test conditions. In response, test rig actuators 603 apply a new test condition to subsystem 2 according to the new set of test signals. The above-described steps are repeated during the test.

In one embodiment, responsive to the received response of subsystem 2, simulator 601 modifies the simulation model 611 by incorporating the response of subsystem 2 under test into the simulation model, so that the simulation model now considers any changes that may occur on the physical subsystem 2 under test, and generates appropriate test conditions and/or load histories for testing subsystem 2 based on the modified simulation model. The response of subsystem 2 may be used as inputs to the simulation model in place of the removed characteristics of the subsystem 2 under test. The improved durability testing is conducted as on the real test track with either an open loop or closed loop driver. The test rig actuators, working with the simulation, apply loads to the vehicle subsystem under test in a way that is similar to the loads developed on a real road. Thus, a vehicle-level evaluation is accomplished which describes the effect that the part under test (e.g., subsystem 2) has on the car's attributes and characteristics (e.g., the simulation model 611). For example, by applying a force or displacement to a suspension, an attribute of the vehicle body such as lean angle, or roll angle, may be extracted from the model. Thus, the result being measured may be a direct response of the part under test or be an attribute value within the vehicle model.

It is noted that the dynamic tester shown in FIG. 6b should be designed using minimum command tracking error. In other words, the time period between a command generated by simulator 601 to apply a specific test condition and the actual application of the test condition on subsystem 2 needs to be kept as short as possible, preferably less than 10 ms. This time period may vary depending on the type of subsystem being tested. For example, testing of roll-over compensation systems may allow for a longer response time period than that for testing a passenger safety subsystem. Possible techniques for reducing the tracking error include inverse rig parametric models and inverse rig system identification models.

Using the exemplary dynamic tester to perform durability testing does not need to gather road data with a full vehicle, and therefore allows earlier testing than otherwise possible. Furthermore, since the physical vehicle component or subsystem under test interacts with the simulation model through feedbacks, changes in the vehicle component or subsystem characteristics result in changes in the applied load or test conditions, as will happen on the real road.

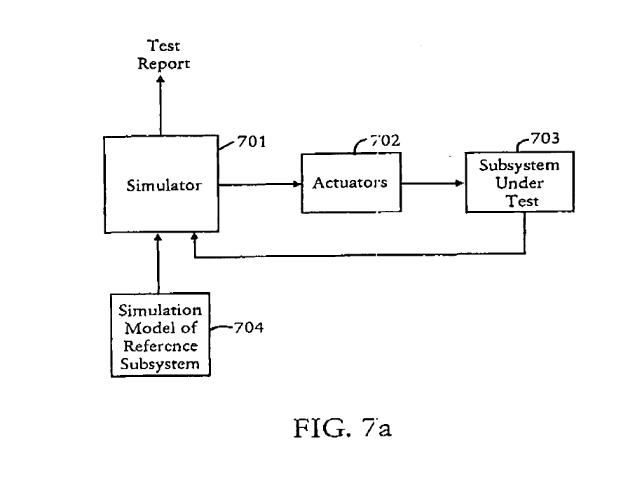

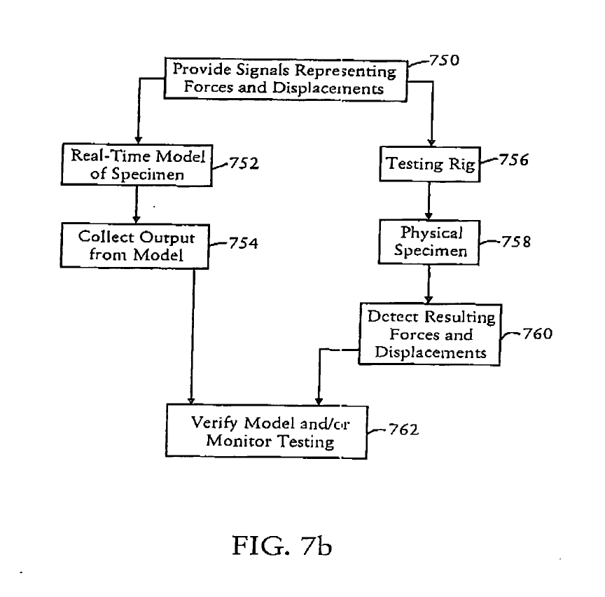

FIG. 7a is a block diagram of another embodiment of a dynamic tester performing a durability test on a subsystem 703 of a vehicle. As shown in FIG. 7, the exemplary tester includes simulator 701 and test rig actuators 702. Subsystem 703 is a physical part under test, such as a vehicle suspension. Simulator 701 includes a simulation model representing characteristics of the vehicle incorporating subsystem 703, or the simulation model described relative to FIGS. 6a and 6b. Simulator 701 has access to a pre-stored simulation model 704 of a reference system corresponding to subsystem 703. The simulation model 704 of the reference subsystem is verified in advance to be identical to the behavior of an ideal subsystem. The physical construction of the tester may be similar to those illustrated in FIG. 4 or 5, or any other constructions that are known to people skilled in the art to be suitable for performing tests.

In operation, simulator 701 generates a first set of test signals based on a test condition database to control test rig actuators 702 to apply a test condition to subsystem 703. The test database is similar to that described earlier. If subsystem 703 is a vehicle suspension, the applied test condition is in the form of displacements or loads applied to the vehicle suspension. Simulator 701 further generates a simulated response of the reference subsystem by applying the same test condition based on the first set of test signals to the simulation model of the reference subsystem.

Signals related to subsystem 703 and its responses to the applied test condition, such as complementary displacements or loads, are collected and sent to simulator 701. Simulator 701 then compares the response or behaviors of subsystem 703 and the simulation response using simulation model 704. The difference of behavior or response between the subsystem 703 and the simulation model 704 is evaluated to determine the stability of the testing and/or to detect early failures or testing accidents. Based on a comparison between the received response of subsystem 703 and the simulated response of the reference subsystem, simulator 701 generates a test result. The above-described steps are repeated during the test.

As a result, durability testing can occur without the need to gather actual road data with a full vehicle, thereby allowing earlier testing than conventionally possible. Also, because the vehicle component interacts with the vehicle model through test rig feedbacks, changes in the vehicle component characteristics will result in changes in the applied load as would be the case in the real world. Thus, the durability results are more realistic than those of conventional durability tests.

FIG. 7b depicts an exemplary flowchart related to additional advantages of the durability testing systems and methods described herein. Initially, in step 750, signals representing the forces and displacements that are to be applied to a subsystem under test are generated. These signals likely arise from portions of a whole vehicle model. These signals are provided to a test rig 756 as well as to a real-time model of the specimen under test 752. The test rig 756 then provides appropriate forces and displacements to the physical specimen 758 using techniques such as those described earlier. The output of the model is collected in step 754 and the resulting displacements and forces caused by the specimen under test are detected and collected in step 760. These two outputs can then be compared for various reasons. For example, initially while the specimen is still new, the output of the model can be compared to the resulting physical output to validate that the model accurately characterizes the physical specimen. The two outputs may also be compared as testing takes place to monitor the specimen's response as compared to the model. Such a comparison may allow earlier detecting of specimen failures and preventing testing accidents.

It is understood that the dynamic testers disclosed herein are usable to test any type of subsystem of a vehicle, including active or passive suspension systems, active roll control systems, braking assistance systems, active steering systems, active ride height adjustment systems, all wheel drive systems, traction control systems, etc. It is also understood that the testers disclosed herein are suitable for testing various types of vehicles, such as automobiles, boats, bicycles, trucks, vessels, airplanes, trains, etc. Different variations and configurations of actuators and supporting posters can be used to implement the dynamic testers described in this disclosure.

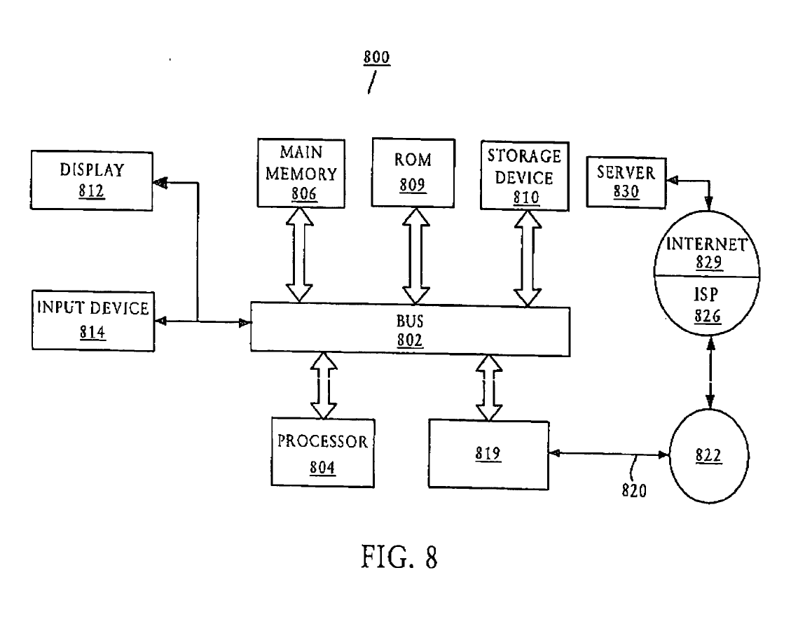

FIG. 8 is a block diagram that illustrates a data processing system 800 upon which an real-time vehicle simulation model of the disclosure may be implemented. Data processing system 800 includes a bus 802 or other communication mechanism for communicating information, and a processor 804 coupled with bus 802 for processing information. Data processing system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Data processing system 800 further includes a read only memory (ROM) 809 or other static storage device coupled to bus 802 for storing static information and instructions for processor 804. A storage device 810, such as a magnetic disk or optical disk, is provided and coupled to bus 802 for storing information and instructions.

Data processing system 800 may be coupled via bus 802 to a display 812, such as a cathode ray tube (CRT), for displaying information to an operator. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812.

The data processing system 800 is controlled in response to processor 804 executing one or more sequences of one or more instructions contained in main memory 806. Such instructions may be read into main memory 806 from another machine-readable medium, such as storage device 810. Execution of the sequences of instructions contained in main memory 806 causes processor 804 to perform the process steps described herein. In alternative embodiments, hard-wired circuitry may be used in place of or in combination with software instructions to implement the disclosure. Thus, embodiments of the disclosure are not limited to any specific combination of hardware circuitry and software.

The term “machine readable medium” as used herein refers to any medium that participates in providing instructions to processor 804 for execution. Such a medium may take many forms, including but not limited to, non-volatile media, volatile media, and transmission media. Non-volatile media includes, for example, optical or magnetic disks, such as storage device 810. Volatile media includes dynamic memory, such as main memory 806. Transmission media includes coaxial cables, copper wire and fiber optics, including the wires that comprise bus 802. Transmission media can also take the form of acoustic or light waves, such as those generated during radio-wave and infra-red data communications.

Common forms of machine readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a data processing system can read.

Various forms of machine-readable media may be involved in carrying one or more sequences of one or more instructions to processor 804 for execution. For example, the instructions may initially be carried on a magnetic disk of a remote data processing. The remote data processing system can load the instructions into its dynamic memory and send the instructions over a telephone line using a modem. A modem local to data processing system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Data processing system 800 also includes a communication interface 819 coupled to bus 802. Communication interface 819 provides a two-way data communication coupling to a network link that is connected to a local network 822. For example, communication interface 819 may be an integrated services digital network (ISDN) card or a modem to provide a data communication connection to a corresponding type of telephone line. As another example, communication interface 819 may be a local area network (LAN) card to provide a data communication connection to a compatible LAN. Wireless links may also be implemented. In any such implementation, communication interface 819 sends and receives electrical, electromagnetic or optical signals that carry digital data streams representing various types of information.

The network link 820 typically provides data communication through one or more networks to other data devices. For example, the network link 820 may provide a connection through local network 822 to a host data processing system or to data equipment operated by an Internet Service Provider (ISP) 826. ISP 826 in turn provides data communication services through the world wide packet data communication network now commonly referred to as the “Internet” 829. Local network 822 and Internet 829 both use electrical, electromagnetic or optical signals that carry digital data streams. The signals through the various networks and the signals on network link 820 and through communication interface 819, which carry the digital data to and from data processing system 800, are exemplary forms of carrier waves transporting the information.

Data processing system 800 can send messages and receive data, including program code, through the network(s), network link 820 and communication interface 819. In the Internet example, a server 830 might transmit a requested code for an application program through Internet 829, ISP 826, local network 822 and communication interface 819. In accordance with embodiments of the disclosure, one such downloaded application provides for automatic calibration of an aligner as described herein.

The data processing also has various signal input/output ports (not shown in the drawing) for connecting to and communicating with peripheral devices, such as USB port, PS/2 port, serial port, parallel port, IEEE-1394 port, infra red communication port, etc., or other proprietary ports. The measurement modules may communicate with the data processing system via such signal input/output ports.

The disclosure has been described with reference to specific embodiments thereof. It will, however, be evident that various modifications and changes may be made thereto without departing from the broader spirit and scope of the disclosure. The specification and drawings are, accordingly, to be regarded in an illustrative rather than a restrictive sense.

What is claimed is:

1. A tester for testing durability of a subsystem of a vehicle, the tester comprising:
at least one test rig actuator configured to apply a test condition to at least a portion of the subsystem;
at least one sensor configured to collect signals related to the portion subsystem;
a data processing system including:
a data processor for processing data; and
a data storage device configured to store machine-executable instructions and data related to a simulation model representing the vehicle not including the portion of the subsystem, wherein the instructions, upon execution by the data processor, control the data processing system to perform the steps of:
generating test signals using the simulation model;
controlling the at least one test rig actuator to apply a test condition to the portion of the subsystem based on the test signals;
receiving response signals of the portion of the subsystem to the test condition based on the test signals; and
generating a durability test result based on the received response signals.

2. The tester of claim 1, wherein the data related to the simulation model is modified based on the received response signals of the portion of the subsystem.

3. The tester of claim 2, wherein the data processing system generates a new test signal using the modified simulation model of the vehicle, and controls the at least one actuator to apply a test condition to the subsystem based on the new test signal.

4. The tester of claim 1, wherein the test condition includes applying at least one or more mutually orthogonal moments or forces.

5. The tester of claim 1, wherein the test condition includes activating the portion of the subsystem.

6. The tester of claim 1, wherein the test condition includes operating the portion of the subsystem.

7. The tester of claim 1, wherein the subsystem includes an engine.

8. The tester of claim 1, wherein the subsystem includes a drivetrain.

9. The tester of claim 1, wherein the subsystem includes a suspension system.

10. The tester of claim 1, wherein the subsystem includes a safety system.

11. A tester for testing durability characteristics of a subsystem of a vehicle, comprising:
a physical specimen of at least a portion of the subsystem;
a computer-based model of a vehicle excluding the physical specimen;
a test rig configured to apply a first input to the physical specimen, the first input generated by the model and related to the physical specimen;
the test rig further configured to detect a response of the physical specimen resulting from application of the first input; and
the test rig further configured to provide signals representing the response as second input to the model, wherein the model uses the second input when executing.

12. The tester of claim 11, wherein the subsystem is one of an engine, a drivetrain, a safety system, and a suspension system.

13. A method of testing durability characteristics of a subsystem of a vehicle, comprising the steps of:
executing a model, said model excluding at least a component of the subsystem;
providing output of the model related to the component as first input to a test rig;
operating the test rig including a physical specimen of the component so as to apply the first input to the physical specimen;
detecting a response of the physical specimen resulting from application of the first input; and
providing signals representing the response as second input to the model, wherein the model uses the second input when executing.

14. The method of claim 13, wherein the subsystem is one of an engine, a drivetrain, a safety system, and a suspension system.

15. A method of testing durability characteristics of a subsystem of a vehicle, comprising the steps of:
executing a first model, said first model excluding at least a component of the subsystem;
executing a second model, said second model including the component of the subsystem;
providing output of the first model related to the component as first input to a test rig and second input to the second model;
operating the test rig including a physical specimen of the component so as to apply the first input to the physical specimen;
detecting a first response of the physical specimen resulting from application of the first input; and
detecting a second response of the second model resulting from application of the second input.

16. The method of claim 15, further comprising the step of:
providing signals representing the first response as third input to the first model, wherein the first model uses the third input when executing.

17. The method of claim 15, further comprising the step of:
comparing the first response with the second response.

18. The method of claim 15, further comprising the step of:
determining if the first model accurately characterizes the physical specimen based at least in part on a comparison of the first response and the second response.

19. The method of claim 15, further comprising the step of:
determining durability characteristics of the physical specimen based at least in part on a comparison of the first response and the second response.

20. The method of claim 15, wherein the subsystem is one of an engine, a drivetrain, a safety system, and a suspension system.

21. The method of claim 15, wherein operating the test rig includes applying one or more mutually orthogonal forces or moments.

22. The method of claim 15, wherein operating the test rig includes activating the component.

23. The method of claim 15, wherein operating the test rig includes operating the component.
